(19) United States
(12) Patent Application Publication
(10) Pub. No.: US 2021/0019158 A1
(43) Pub. Date: Jan. 21, 2021

(54) SYSTEMS AND METHODS TO CONVERT MOBILE APPLICATIONS TO DISTRIBUTED PLATFORMS

(71) Applicant: Kevin D. HOWARD, Mesa, AZ (US)

(72) Inventor: Kevin D. HOWARD, Mesa, AZ (US)

(21) Appl. No.: 16/932,756

(22) Filed: Jul. 18, 2020

Related U.S. Application Data
(60) Provisional application No. 62/875,847, filed on Jul. 18, 2019.

(51) Int. Cl. G06F 9/455; G06F 9/50; G06Q 20/32; G06F 9/48; A63F 13/35

(52) U.S. Cl. CPC G06F 9/45529; G06F 9/5077; G06Q 20/322; G06Q 30/0215; G06F 9/5083; G06F 9/485; A63F 13/35; G06Q 20/326

(57) ABSTRACT

Computing and software systems are provided that include one or more mobile devices and one or more system servers. The mobile devices are configured to execute mobile applications, such as direction routing, text messaging, games, mobile apps, etc. These useful mobile applications are considered attractants—attractive applications. The attractive applications can carry a payload consisting of an auto-monetizable application, a cached or hidden application, such that it becomes possible to use some of the billions of idle compute cycles while the attractive application is executing—e.g., to generate funds that are not directly associated with the attractive application.

### PRIORITY

This Application claims priority to and the benefit of U.S. Provisional Patent Application No. 62/875,847, filed Jul. 18, 2019, which is incorporated fully herein by reference.

### TECHNICAL FIELD

The present invention relates generally to systems, methods, and computer programs for converting mobile and like applications to distributed platforms.

### BACKGROUND OF THE INVENTION

Many applications produce monetizable results but require a very large-scale processing infrastructure in order to produce those results. For example, cryptocoin mining directly results in the creation of cryptocurrency, but the associated costs—the initial cost of the computer hardware and the on-going cooling and electrical costs—limit the scale-up and profitability of such applications.

There has been some effort to convert existing platforms to generate revenue from applications directly. For instance, U.S. Patent Application Publication 2020/0097951 couples a remote cryptocurrency system with a user's body movement as detected by the user's local sensor to create the “proof-of-work” used to generate blockchains. While this cryptocurrency system can be a server or a network, including mobile networks, it does not take full advantage of the users' existing, local, direct computer resources.

Other systems, such as that taught in U.S. Patent Application Publication U.S. 2020/0151682 distribute cryptocurrency analogous to how online banks distribute standard currency, which does not allow for the “farming” of new currency. Standard distributed cryptocurrency “farming” requires either the ownership of the distributed network, entailing legal issues concerning the surreptitious use of other people's equipment, or the consumption of processor bandwidth such that other desired activities are impacted.

In addition, expecting users to provide compute resources without compensation is not sustainable. There are other directly monetizable activities that are not blockchain-related, such as image processing, analytics, and oil and gas codes that could take advantage of an extremely large, low-cost distributed or parallel processing platform if the above-mentioned problems did not exist.

As such, there is a need for new and improved computing systems and methods to address these deficiencies.

### SUMMARY OF THE INVENTION

There are untold billions of compute cycles sitting idle every day on mobile devices. The problem is that control of those compute cycles is as distributed as the devices themselves, making access to these resources difficult. Currently, useful mobile applications (direction routing, text messaging, etc.), mobile games, and eBooks are very popular. These useful mobile applications and games can be considered attractants for use of those devices. If the attractive applications can carry a payload consisting of an auto-monetizable application, as a background, or hidden (cached) application, then the systems and methods of the present invention make it possible to use some of these billions of idle compute cycles while the attractive application is executing and to generate funds that are not directly associated with the attractive application.

These funds can then be shared by the attractive application provider, the cached application provider, as well as by the users. If activation of the attractive application controls when the cached application is in operation, then it is performing the duties of a platform. The income to the attractive application provider, as well as the user, is new income, not obtainable without the cached application. The cached (or hidden) application generates income without dedicated hardware, cooling, or electricity costs, and the mobile device owner or user controls which and when an attractive application is used to host the cached application.

Examples of applications using idle compute cycles of the mobile device include any data processing application as long as there is an income stream associated with it. For example, real-time image processing from drone, aircraft or vehicular data, oil and gas seismic image processing, big data analysis, land crypto coin mining, and the like. Most applications are not auto-monetizable, with the exception of the crypto coin mining. However, even non auto-monetizable applications and datasets are monetizable via selling the inexpensive processing services to those with processing requirements and assigning portions of the income to the devices that participate in that processing.

An opt-in model is used so that mobile users choose to allow the use of their devices by the cached application, eliminating legal issues. The incentive is monetary. Funds generated by the cached application can be delivered to a user in the form of in-game credits, cryptocurrency awards, gift cards, direct cash disbursements, or other value-sharing models. Also, it is possible for multiple users to share the generated value among themselves or collectively share with a philanthropic organization. Having a fixed attractive application is not strictly necessary as the components needed to form the platform could be instantiated as a wrapper around the attractive application, allowing the platform controls to be visible while retaining the attractive application's full interface. The wrapper instantiation means that the device owner need not share revenue with the application provider. Because the device is used for other, simultaneous purposes, the cost of their compute cycles is inherently low. This offers organizations the ability to, inexpensively, utilize these scavenged compute cycles at low cost while offering the device owners a sustainable incentive to utilize their equipment.

Typically, when mobile device compute cycles are combined, only distributed computing techniques are used. Since modern mobile devices contain multiple cores, distributed, parallel, and mixed distributed/parallel computing techniques can be used. A platform that uses both distributed and parallel techniques offers the opportunity to greatly enhance the performance of any application that uses it but only if the compute load balance across both devices and cores is maintained. This can be accomplished using dynamic run-time load balancing techniques like those disclosed in U.S. Pat. No. 10,496,514, which is fully incorporated herein by reference. Because of the huge number of devices available, techniques like those disclosed in U.S. Patent Application Publication No. 2020/0210162, which is fully incorporated herein by reference and which uses reversible functions generated for the Time Affecting Linear Pathways (“TALPs”) of an application, could be used, greatly decreasing the processing time of the cached application.

Aspects, methods, processes, systems and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIG. 1 shows a diagram of a computing system and method for converting mobile applications to distributed platforms, including one or more mobile device and one or more cloud servers, in accordance with embodiments of the present invention.

FIG. 1a shows a block diagram of a computing system and method for converting mobile applications to distributed platforms, in accordance with embodiments of the present invention.

FIG. 2 shows a screen display including an attractive application user interface area and a cached application controller application (“CACA”) interface area having a Select Apps selection or button, in accordance with embodiments of the present invention.

FIG. 3 shows a screen display including an attractive application user interface area and a CACA interface area not having a Select Apps selection or button, in accordance with embodiments of the present invention.

FIG. 4 shows a screen display including an attractive application user interface area and a CACA interface area with exemplary control selections or buttons, in accordance with embodiments of the present invention.

FIG. 5 shows a screen display including revenue display area and a CACA interface area, in accordance with embodiments of the present invention.

FIG. 6 shows a screen display including a revenue display area, a share revenue display area, and a CACA interface area, in accordance with embodiments of the present invention.

FIG. 7 shows a screen display including a user core selection display area and a CACA interface area, in accordance with embodiments of the present invention.

FIG. 8 shows a screen display including an application's display area and a CACA interface area, in accordance with embodiments of the present invention.

FIG. 9 shows a flow chart of operations of a CACA at a start CACA message, in accordance with embodiments of the present invention.

FIG. 10 shows a flow chart of operations of a CACA at an end CACA message, in accordance with embodiments of the present invention.

FIG. 11 shows a flow chart of operations of a CACA at a revenue request message, in accordance with embodiments of the present invention.

FIG. 12 shows a diagram of operative communication and interfacing between a CACA, a cached application server (“CAS”) and a cached application data server (“CADS”), in accordance with embodiments of the present invention.

FIG. 13 shows a flow chart of operations of a CAS at a connection request message, in accordance with embodiments of the present invention.

FIG. 14 shows a diagram of operative communication and interfacing between a cached application (“CA”) and a CADS, in accordance with embodiments of the present invention.

FIG. 15 shows a flow chart of a messages communicated between a CA and a CADS, in accordance with embodiments of the present invention.

### DETAILED DESCRIPTION OF PREFERRED EMBODIMENTS

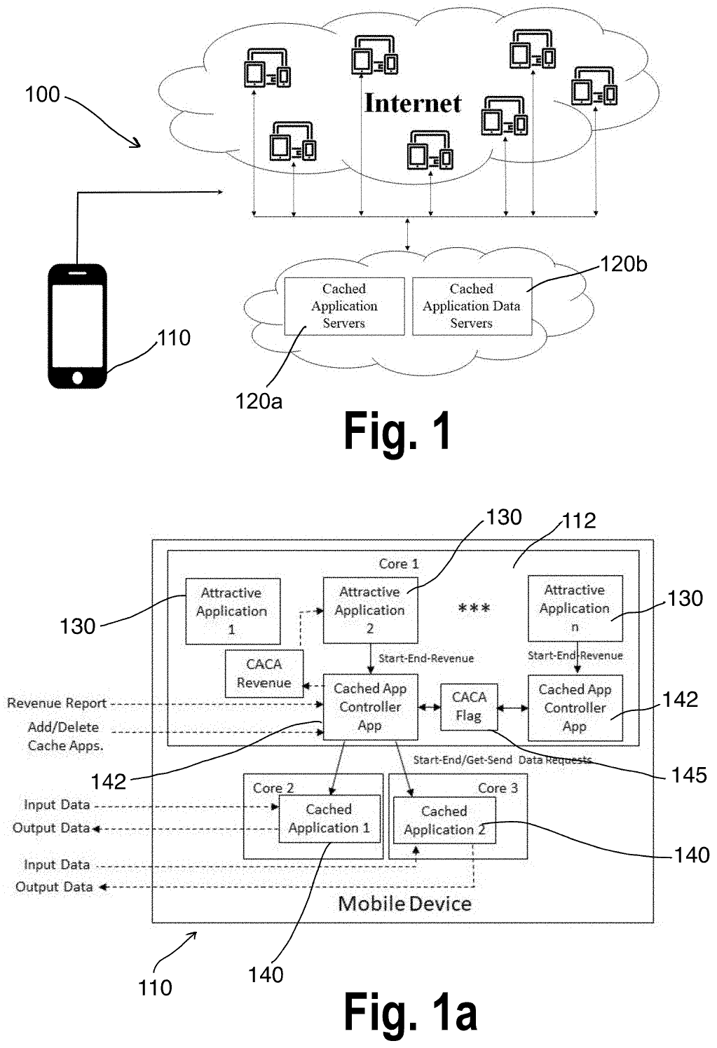

Referring generally to FIGS. 1-15, exemplary aspects of computing systems and methods for converting mobile applications to distributed platforms is provided.

As shown in FIGS. 1-1a, the computing and software system 100 of the present invention can include one or more mobile devices 110 (e.g., smartphones, tablets, etc.) and one or more system servers (e.g., cloud-based servers 120a, 120b). The mobile devices 110 are configured to execute mobile applications 130, such as direction routing, text messaging, games, apps, etc. These useful mobile applications 130 are considered attractants—attractive applications. The attractive applications 130 can carry a payload consisting of an auto-monetizable application, a cached or hidden application 140, such that it becomes possible to use some of the billions of idle compute cycles while the attractive application 130 is executing to generate funds that are not directly associated with the attractive application 130.

These funds can be shared by both the attractive 130 and the cached 140 applications. Since the attractive application 130 controls when the cached application (“CA”) 140 is in operation, it is performing the duties of a platform. The income to the attractive application 130 is new income, not obtainable without the cached application 140. The CA 140 generates income without hardware, cooling, or electricity costs, and the mobile device 110 owner or user still controls which and when attractive applications 130 are used.

If both the attractive applications 130 and CAs 140 are controlled by the same entity, then general-purpose computing, not just directly monetizable computing, is performed using CAs 140.

Examples of applications using idle compute cycles of the device 100 include any data processing application as long as there is an income stream associated with it. For example, real-time image processing from drone, aircraft or vehicular data, oil and gas seismic image processing, big data analysis, land crypto coin mining, and the like. Most applications are not auto-monetizable, with the exception of the crypto coin mining. However, even non auto-monetizable applications and datasets are monetizable via selling the inexpensive processing services to those with processing requirements and assigning portions of the income to the devices that participate in that processing.

Referring to FIGS. 1-11, in order to minimize the impact on an attractive application 130 when a CA 140 is active, the CA 140 can be placed on a separate core 112 of the mobile device 110. This can be accomplished by using a cached application controller application (“CACA”) 142. Only start and end messages are required between an attractive application 130 and a CACA 142. Once invoked, the CACA 142 manages the CAs 140. The CACA 142 can independently activate or deactivate the CAs 140. Multiple cores can also be used for a single cached application. Cloud-based servers can add, change, or delete cached applications associated with particular CACAs using an add/delete cache app message.

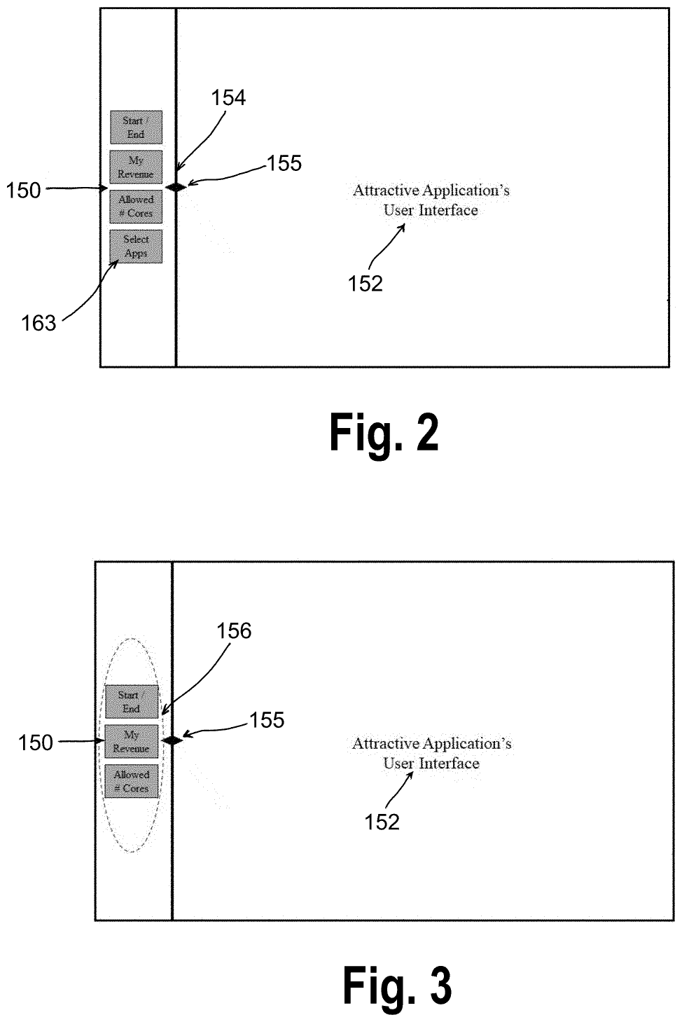

Referring generally to FIGS. 2-8, a CACA wrapper interface 150 allows the mobile device owner or user to quickly opt-in or out of allowing CAs 140 to execute. The CACA interface 150 can be hidden or visible by using, selecting, or otherwise interacting with region 152, or other designated area displayed. With certain embodiments, two types of CACA interfaces 150 can be included. The first is the user-selectable interface which contains the ability to attach the CACA interface to an already existing user application via viewing or selecting in area 154 (e.g., FIG. 2). The second allows an application distributor to permanently attach the CACA interface 150 to a particular application, without the user's ability to attach the CACA interface to another application or remove the CACA interface as shown with area 156 of the interface (e.g., FIG. 3).

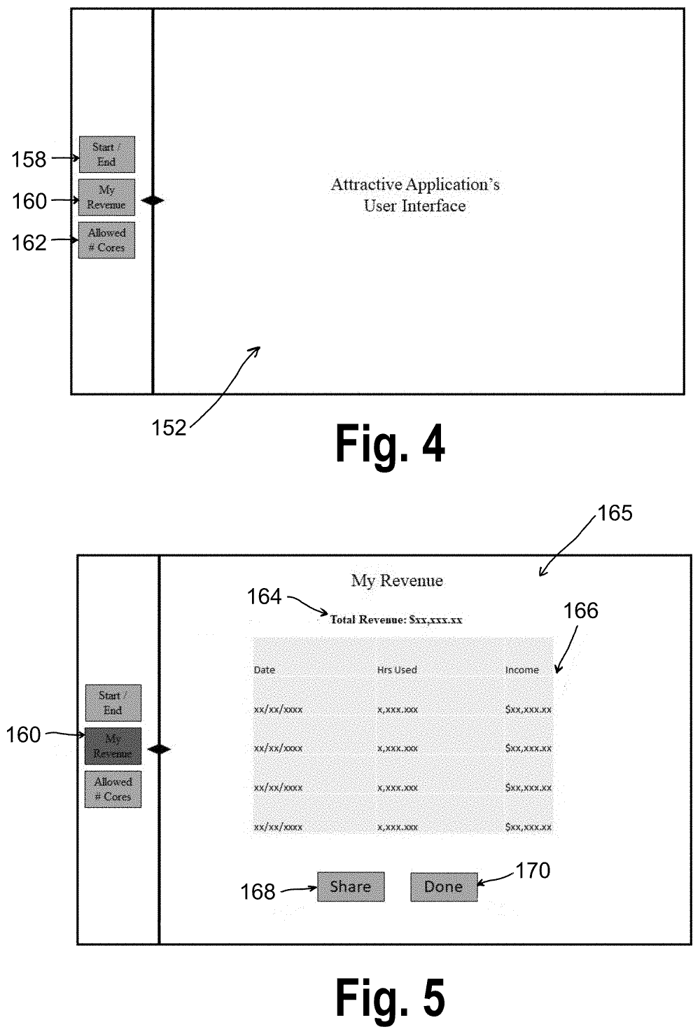

With various embodiments, as shown in FIG. 4, the CACA interface 150 can include a plurality of selections, inputs, or control buttons, including user-selectable inputs or buttons 158, 160, 162, and 163. Further, an interface resizer 155 can be provided to allow for user-adjustment of the size and location of the CACA interface 150 being displayed.

Selection of the Start/End button 158 can toggle between Start and End options with Start toggle designation meaning opt-in and the End toggle designation meaning opt-out. For illustrative purposes, darker shaded selections or buttons indicate that the particular button or input option has been selected.

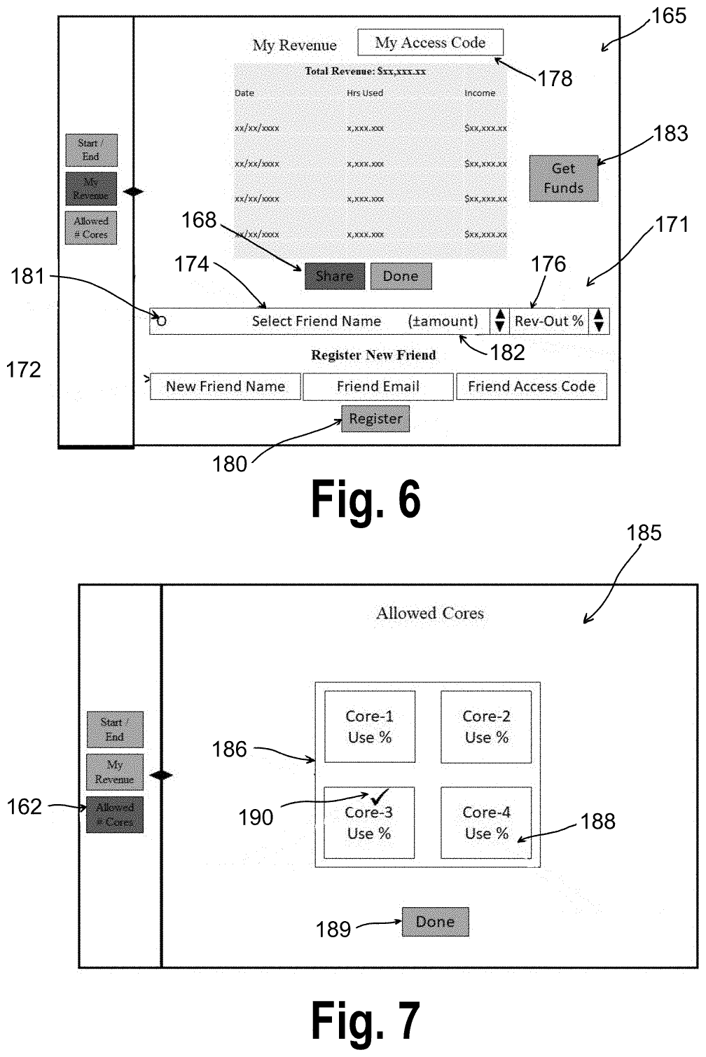

Referring to FIGS. 5-6, the My Revenue selection or button 160 causes the My Revenue screen 165 to display. The My Revenue display 165 shows the total amount of revenue in area 164 that has been generated for the device owner or user. In addition, other relevant information can be displayed in area 166, including a list of revenue generation dates, number of hours needed to generate the revenue, revenue generated on that date, and the like. Two additional control selections or buttons associated with the My Revenue display screen can be included: Share 168 and Done 170. Selecting the Share button causes the Shared Revenue display screen 171 (FIG. 6) to be displayed while the Done button removes the My Revenue display screen 165, allowing the original Attractive Application display 152 to reappear or redisplay.

As shown in FIG. 6, the Shared Revenue display area 171 gives the mobile device owner or user the ability to add revenue-sharing friends at selection or button area 172 to a list of friends provided at area 174. The mobile device owner or user can send all or some of their earnings at area 176 to their list of friends 174. To share revenue, in certain embodiments, both the sender and receiver (e.g., a user using the application on a separate mobile device) will have a unique access code that can be selected or otherwise inputted at area 178. The unique access code, valid user name, and valid email address can be used by the mobile device owner or user to register a friend. Once the friend information is entered, the mobile device owner or user can select the Register button 180. A registered friend is added to the friend lists of both friends, on both devices. Revenue direction or status indicators can be displayed at area 181. For instance, if neither friend is sharing revenue then an “N” indicator, for neither income nor expense, is displayed for both friends. If the Rev-Out % of one friend is greater than zero while the other friend's Rev-Out % is zero, then the friend receiving without sending revenue can have an “I” indicator, for income generating, displayed by their shared friend's name, while the sending friend has an “O” indicator, for outflow or expense, displayed. If both friends have their Rev-Out % greater than zero then both will show an “IO” indicator, meaning income and outflow, displayed on their respective friends list. The total net amount sent to or received from a friend is displayed next to the friend's name at area 182. Selecting a friend's name gives the option to remove or delete the friend from the friends list. The Get Funds selection or button 183 transfers the accumulated revenue to the mobile device owner or user's bank, credit card, or other repository using industry standard funds transfer methods. Selecting the Done selection or button causes the Share Revenue display screen 171 to be removed and the My Revenue display screen 165 to reactivate or redisplay.

Referring to FIG. 7, selection of the Allowed #Cores button 162 causes the User's

Core Selection screen 185 to be displayed. The User's Core Selection screen 185 displays a graphic of all available processing cores 186 and the percentage of total processing being used by each core at 188. Selecting a particular core toggles its selected/not selected indicator or indicia 190 (e.g., a checkmark or like indicia). Each selected core can be used to process a cached application by the CACA. Multiple cores on the same mobile device can be used as a parallel processing engine. As disclosed in U.S. Pat. No. 10,496,514, which is fully incorporated herein by reference, if the application running in parallel is non-linear, then the speed increase of the application is also non-linear. In other words, it is possible for the sum of parallel core performance to be greater than the individual cores themselves. This offers greater advantage than using distributing computing alone. Selection of the Done button 189 causes the User's Core Selection screen 185 to be removed and the Attractive Application's user interface 152 to be redisplayed.

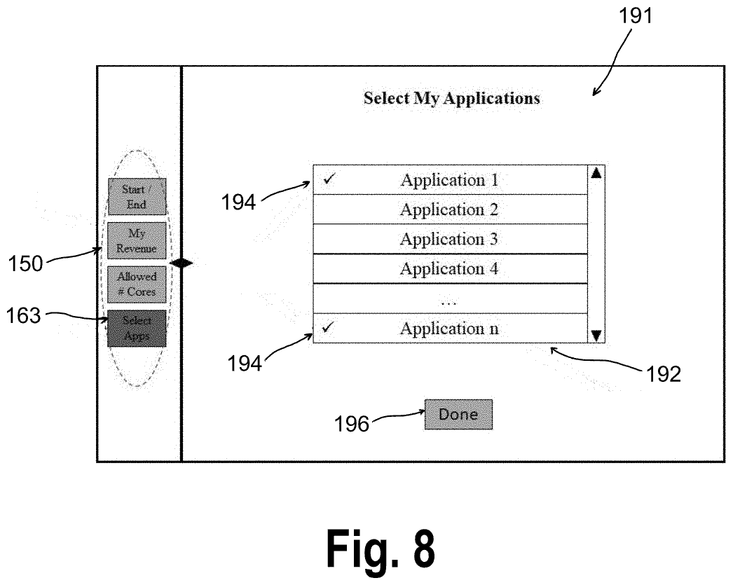

Referring to FIG. 8, selection of the Select Apps button 163 causes the Select My Applications screen 191 to display, which contains a list of the user's available applications 192 (e.g., attractive applications) and selected applications shown with the selected application indicia 194 (e.g., a checkmark or like indicia). The application can be selected and deselected by selecting the same listed application more than once. Selecting an application causes it to be associated with the CACA while deselecting an application removes the association. Selecting the Done button 196 causes the Select My Applications display 191 to be removed and the attractive application's user interface 152 to be redisplayed. Whenever an application is invoked that has been selected, it can be shown within the CACA wrapper interface 150.

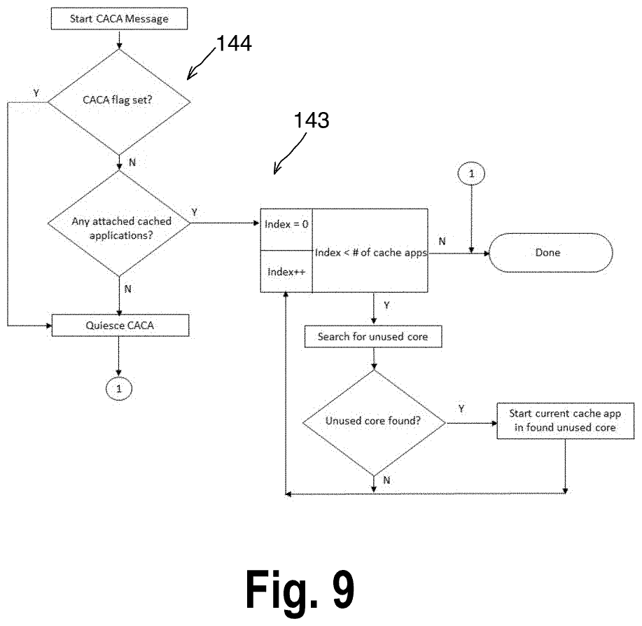

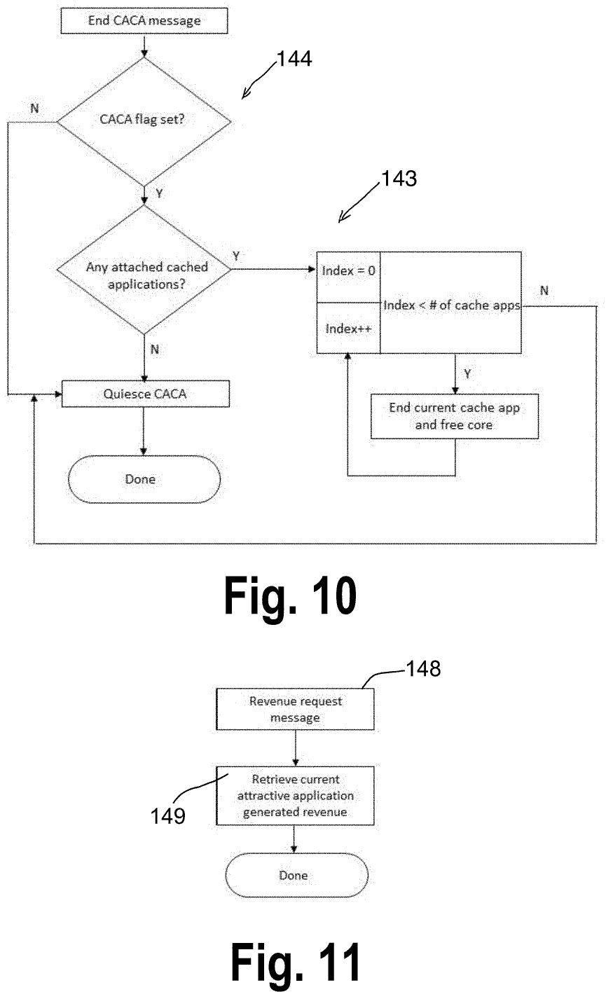

Referring to FIGS. 9-10, the CACA 142 can perform two checks: a cached application check 143 and a controller active check 144. The cached application check 143 determines which CAs 140 are to be invoked. Those applications are invoked until there are no additional available cores. The invocation activates a CA 140 on an available core. If no additional core is available, then that CA 140 is not invoked. An attempt to invoke an uninvoked CA can occur periodically while the attractive application 130 is active. The second check 144 determines if there is already an active CACA 142 by checking the CACA existence flag 145. If the flag 145 is true, then the current CACA 142 is quiesced. If the flag 145 is false, then the flag is set to true and the associated CAs 140 are invoked. A periodic attempt to invoke an uninvoked CACA 142 can be made as long as the attractive application 130 is active.

FIG. 11 shows a diagram of operations of a CACA 142 upon receiving a revenue request message at step 148. Information concerning the income or revenue generated by a particular mobile device 110 is stored on that device so that the attractive application's value can be assessed by the attractive application 130 itself using an income or revenue message. Upon receiving the revenue request message, the current attractive application generated revenue data is retrieved at step 149, at which time that particular process or method is done or complete.

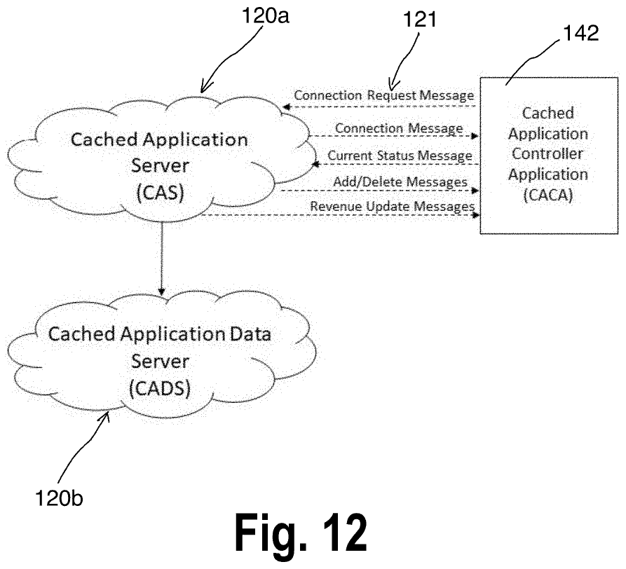

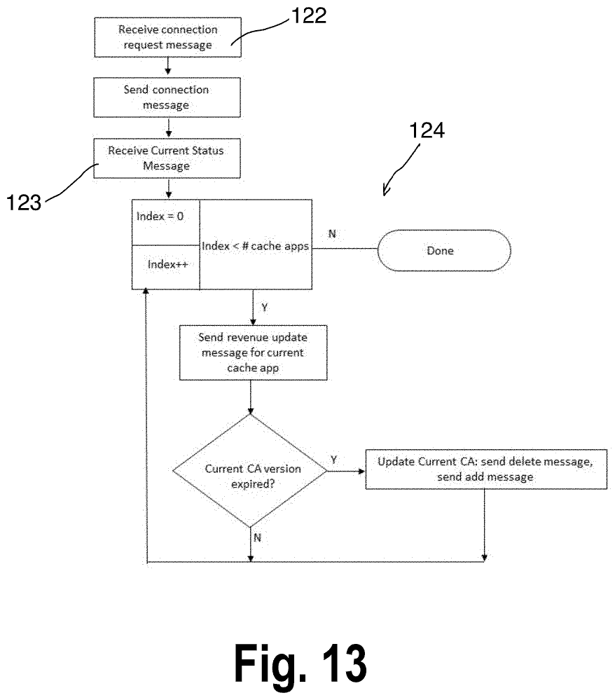

Referring to FIGS. 12-13, a cloud-based Cached Application Server (“CAS”) 120a contains the latest copy of each CA 140 as well as the data for each CA and the results of the deployed CAs. The CAS 120a sends and receives a plurality of messages 121 to and from the CACA 142. The CAS 120a receives a connection request message 122 from each newly started CA 140 and a disconnection request from each CA 140 that has ended. The connection request 122 is followed by a current status message 123 which gives the version number of the CA 140. This allows the CAS 120a to know when to update the CA 140.

There are two required messages, for various embodiments, as shown in step 124: the Add Cache Application (“ACA”) message and the Delete Cache Application (“DCA”) message. A CA update consists of a DCA message followed by an ACA message sent from the CAS 120a to the CACA 142. To generate multiple copies, one per computing core, of a particular CA 140 requires multiple ACA messages, each with the same CA 140 indicated, sent from the CAS 120a to the CACA 142. If multiple ACAs for the same CA 140 are sent, they must contain a contiguous CA index number to differentiate them. The CAS 120a passes the connection and active CA 140 information to a Cached Application Data Server (“CADS”) 120b for data management. Operative bidirectional communication occurs between the CAS 120a and the CADS 120b.

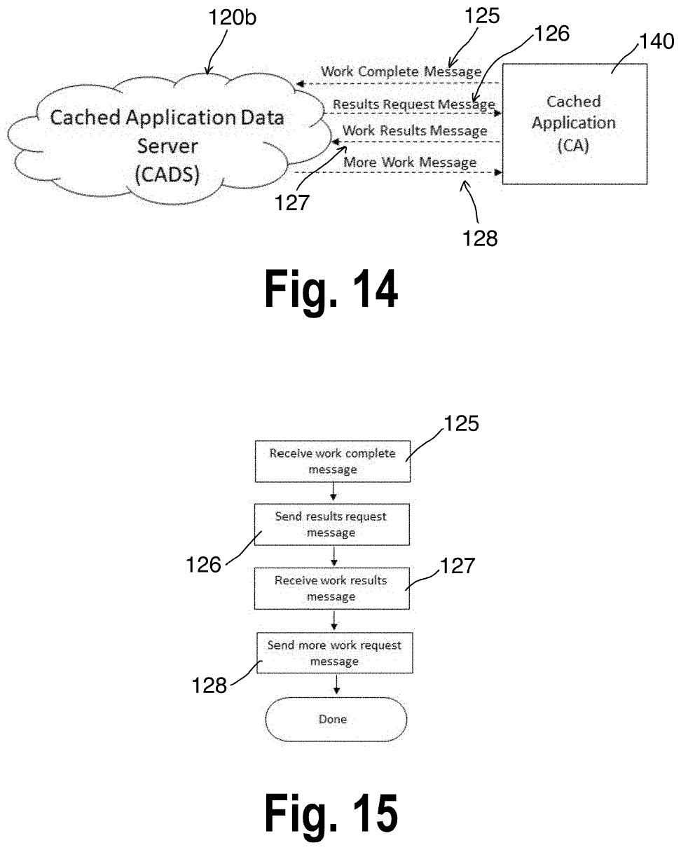

Referring to FIGS. 14-15, for various embodiments, each CA 140 can control its own input and output requests, meaning that there is a coordinating CADS 120b for the cached application 140. Data is sent from/to each mobile device's 110 CA 140 and a cloud-based CADS 120b. There are four required messages for certain embodiments of the present invention: Work Complete (“WC”) 125, Results Request (“RR”) 126, Work Results (“WR”) 127, and More Work (“MW”) 128. The WC 125 is initiated by the CA 140, informing the CADS 120b that the CA 140 is available to receive work and that there are prior work results available. The RR 126 is initiated by the CADS 120b from the receipt of a WC 125. The purpose of the RR 126 is to initiate the transfer of results data from the CA 140 to the CADS 120b. The WR 127 contains the results data from the CA 140. The MW 128 is initiated by the CADS 120b, giving additional work to the CA 140. Interruption of a data transfer will result in its continuation when the CA 140 reconnects. Data transmitted from a CA 140 to the CADS 120b and from the CADS 120b to another, different CA 140 can be used as a cross-communication system. An integrated cross-communication system allows the CAs 140 to be parallelized, resulting in a CACA-based distributed parallel processing system.

Various computing devices, such as the mobile computing devices 110 (e.g., smartphones, tablets, etc.) can be included and adapted to process and carry out the aspects, computations, and algorithmic processing of the hardware and software systems and methods of the present invention. Computing systems and devices of the present invention may include a processor (e.g., multi-core), which may include one or more microprocessors and/or one or more circuits, such as an application-specific integrated circuit (ASIC), field-programmable gate arrays (FPGAs), etc. Further, the devices can include a network interface. The network interface is configured to enable communication with a communication network or the Internet, other devices and systems, and servers, using a wired and/or wireless connection.

The devices or computing systems explicitly and implicitly taught for use with and as an aspect of the present invention may include memory, such as non-transitive, which may include one or more non-volatile storage devices and/or one or more volatile storage devices (e.g., random access memory (RAM)). In instances where the devices or computing systems include a microprocessor (e.g., multi-core), computer readable program code may be stored in a computer readable medium or memory, such as solid-state drives, mechanical drives, optical drives, memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The devices or computing devices may include an input device. The input device is configured to receive an input from either a user (e.g., admin, user, etc.) or a hardware or software component. Examples of an input device include a touch screen, software enabling interaction with a touch screen, keyboard, mouse, microphone or inputted audio, etc. The devices can also include an output device. Examples of output devices include mobile device screens, tablet screens, monitors, televisions, speakers, remote screens, etc. The output device can be configured to display images, media files, text, or video, or play audio to a user through speaker output.

Server processing and storage systems 120a, 120b for use or connected with the systems and aspects of the present invention, can include one or more microprocessors (e.g., multi-core), and/or one or more circuits, such as an application specific integrated circuit (ASIC), field-programmable gate arrays (FPGAs), etc. A network interface can be configured to enable communication with a communication network or the Internet, using a wired and/or wireless connection, including communication with devices or computing devices disclosed herein. Memory can include one or more non-volatile storage devices and/or one or more volatile storage devices (e.g., random access memory (RAM)). In instances where the server system includes a microprocessor, computer readable program code may be stored in a computer readable medium, such as solid-state drives, mechanical drives, optical drives, memory devices (e.g., random access memory, flash memory), etc. While various embodiments have been described above, it should be understood that they have been presented by way of example only, and not limitation. Thus, the breadth and scope of the present disclosure should not be limited by any of the above-described embodiments or examples. Moreover, any combination of the above-described elements in all possible variations thereof is encompassed by the disclosure unless otherwise indicated herein or otherwise clearly contradicted by context.

References to methods and steps such as inputting, entering, selecting and the like can include manual user inputs or selections, or direct generation and insertion/inclusion of data via software.

Additionally, while the methods described above and illustrated in the drawings are shown as a sequence of steps or processes, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements and methodologies can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, section (f) or sixth paragraph of 35 U.S.C. are not to be invoked unless the specific terms “means for” or “step for” are recited in a claim.

What is claimed is:

1. A method of converting one or more mobile applications on a mobile device to a distributed platform, comprising:
providing a cached mobile application;
providing an attractive application, wherein the attractive application is linked to and configured to carry a payload of the cached mobile application; and
processing at the mobile device such that idle compute cycles of the mobile device are used by the cached mobile application while the attractive application is executing.

2. The method of claim 1, wherein the mobile device is a smartphone.

3. The method of claim 1, wherein the attractive application is a mobile app.

4. The method of claim 1, wherein the attractive application is a game.

5. The method of claim 1, further including providing a wrapper cached application interface.

6. The method of claim 5, wherein the wrapper cached application interface includes one or more selectable inputs to start or end the carrying of the cached application payload.

7. The method of claim 5, wherein the wrapper cached application interface includes one or more selectable inputs to configure revenue display and sharing.

8. The method of claim 5, wherein the wrapper cached application interface includes one or more selectable inputs to designate processor core usage for the mobile device.

9. The method of claim 5, wherein the wrapper cached application interface includes one or more selectable inputs to configure attractive applications to link with.

10. The method of claim 1, further including generating revenue with the cached mobile application from the the idle compute cycles of the mobile device.

11. The method of claim 1, further including providing a cached application controller application (CACA) to facilitate processing and control between the attractive application and the cached mobile application.

12. The method of claim 11, further providing one or more cloud-based servers in operative communication with the CACA.

13. The method of claim 12, wherein the one or more cloud-based servers includes one or more cached application servers and one or more cached application data servers.

14. A method of converting one or more mobile applications on a mobile device to a distributed platform, comprising:
providing a cached mobile application and a cached application controller application (CACA);
providing an attractive application, wherein the attractive application is linked to and configured to carry a payload of the cached mobile application via the CACA;
processing at the mobile device such that idle compute cycles of the mobile device are used by the cached mobile application while the attractive application is executing; and
providing one or more cloud-based servers in operative communication with the CACA.

15. The method of claim 14, wherein the mobile device is a smartphone.

16. The method of claim 14, wherein the attractive application is a mobile app.

17. The method of claim 14, wherein the attractive application is a game.

18. The method of claim 14, further including providing a wrapper cached application interface configured to facilitate processor core usage and attractive application linking.

19. The method of claim 14, further providing a wrapper cached application interface configured to facilitate revenue control and sharing based on operation of the cached mobile application.

20. The method of claim 14, wherein the one or more cloud-based servers includes one or more cached application servers and one or more cached application data servers.
